(19) United States
(12) Patent Application Publication
(10) Pub. No.: US 2006/0227961 A1
(43) Pub. Date: Oct. 12, 2006

(54) Apparatus and method for load balancing contact communications

(75) Inventors: Jeremy Lai, Sheffield (GB); Jonathan Burgess, Near Ulverston (GB)

Correspondence Address: WIGGIN AND DANA LLP;ATTENTION: PATENT DOCKETING, ONE CENTURY TOWER, P.O. BOX 1832, NEW HAVEN, CT, 06508-1832, US

(73) Assignee: ALAI LIMITED

(21) Appl. No.: 11/317,395

(22) Filed: Dec. 22, 2005

(30) Foreign Application Priority Data
Jun. 25, 2003 (WO) PCT/GB04/02753

(51) Int. Cl. H04M 3/00; H04M 5/00

(52) U.S. Cl. 379/265.02; 379/265.05; 379/265.11; 379/266.04

(57) ABSTRACT

Apparatus and method for load balancing communication contacts between a plurality of remote, non-associated contact centres in a commercial context. A centralised processing hub is configured to receive and route communication traffic between contact centres based on a number of specific contact routing conditions. A network is configured between contact centres and the central processing hub which manages routing of contact interactions between contact centres utilising a service by which data relevant to the routed contact is presented and by which data may be captured, processed and transferred. Contact centre specific data may be shared with the central hub to enable more efficient resource management in the face of fluctuations in in-bound contact traffic. The central processing hub provides a centralised market infrastructure in which contact resource capacity may be traded under a buy and sell scenario.

### CROSS-REFERENCE TO RELATED APPLICATION

This patent application claims the benefit of an earlier filing date under 35 U.S.C. § 120 and 35 U.S.C. § 363 of copending, International Patent Application Serial No. PCT/GB2004/002753, which designated the United States and has a priority date of Jun. 25, 2003.

### FIELD OF THE INVENTION

The present invention relates to apparatus and method for the centralised load balancing of communication contacts between a plurality of contact centres.

### BACKGROUND TO THE INVENTION

A basic requirement of contact centres is that they deal with user contacts promptly. How effectively this is achieved is often measured as the contact centre's service levels. This is often primarily defined as the proportion of contacts handled within a predetermined target time. Fundamental to achieving a target service level is a contact centre's ability to match successfully resources with inbound contact traffic intensity.

Workforce management solutions have been developed to calculate the resources required to handle a predicted level of contact traffic intensity within a predefined service level parameter. Despite the sophistication of these, contact centres face a number of problems in successfully meeting good target service levels. In particular, the highest service level a contact centre can reasonably aim to achieve is normally constrained by economic considerations. In addition, actual call traffic invariably deviates from even the best predictions.

It is generally accepted that a proportion of contacts will inevitably queue beyond the contact centre's target wait-time or never be dealt with at all. The resource required to reduce this proportion becomes uneconomic beyond certain levels.

Furthermore, deviation of actual contact traffic intensity from predictions affects service levels. When contact traffic intensity exceeds predictions the ability to meet the target service level parameter is compromised, resulting in a greater proportion of contacts than expected queuing beyond the target wait-time. Conversely, contact traffic intensity falling below predictions results in over-staffing which is uneconomic.

Various contact centre management systems and processes have been proposed in which a central management system controls resourcing to a plurality of remote agents, examples include: US20030214950, US20030108183, US 20020001300, U.S. Pat. No. 6,320,956, U.S. Pat. No. 6,049,602, U.S. Pat. No. 6,175,564, U.S. Pat. No. 6,373,836, U.S. Pat. No. 6,122,365, WO 0049794, GB 2342529. In particular, US2002172347 discloses an arrangement where ‘overflow’ calls are directed to different contact centres, based on parameters specific to each contact centre. In operation, a server identifies an appropriate, alternative overflow contact centre for receiving the overflow call and transfers the overflow call to the identified contact centre.

Known contact centre management systems provide for load balancing by re-routing contact calls and/or data to alternative contact centres in situations of call traffic saturation. However, the inventors have identified various limitations associated with prior art systems, for example:

1. Load balancing or overflow of calls in situations of call traffic saturation typically takes place between contact centres under the control of the same organisation and/or its suppliers operating under similar contact management systems and/or processes. That is, the available resource is limited to contact centres under the control of the same organisation and/or its suppliers operating under similar management systems and/or procesess in order to avoid compatibility problems.

2. Known systems do not provide apparatus or method configured to process in real time all contact types (whether sales order, balance enquiry, customer service enquiry, or other types of contact) and electronic contact media (whether telephony, e-mail, web/internet, SMS, or other electronic media) in load balancing or overflow situations.

Accordingly, there is a requirement for apparatus and method for on-demand contact inter-flow and processing by a plurality of remote, non-associated service provider contact centres configurable to manage resources efficiently in the face of unpredictable flux in contact traffic.

### SUMMARY OF THE INVENTION

The inventors provide a centralised load balancing hub configured for the routing of a plurality of different communication contact types over a plurality contact centres. In particular, the apparatus and method of the present invention is capable of routing communication contacts between non-associated contact centres operating under limited, different or no communication contact management systems.

Moreover, a centralised contact resource trading facility is provided in which contact centre resource capacity may be traded as a marketable commodity. A centralised hub enables contact centre agent capacity to be traded in real-time enabling contact centres to manage resources more efficiently in the face of fluctuations in inbound communication contact traffic intensity. The centralised trading resource may be configured to square out contact centre agent capacity positions by automatically matching short positions with long positions according to a plurality of contact routing conditions. The process of squaring out refers to the exercise of buying or selling a commodity in order to have a neutral trading position in that commodity. Moreover, a position refers to a situation in which a trader has bought a commodity but not yet sold it on (long position) or has sold a commodity but not yet bought it back in (short position). A trading facility is provided which may be constant and ongoing rather than being a series of separate trades with varying objectives triggered automatically by external conditions or events.

By generating, routing and presenting a universal interface platform to any one of the plurality of contact centres, the centralised processing hub enables each contact centre, party to the network, to fully process a communication contact having access to relevant data, e.g. account data, personal data, product data etc. The apparatus and method of the present invention is configured for use with a plurality of independent, non-associated organisations that do not have an economic link. A fully integrated network of contact centres is thereby established wherein the efficient processing of contact traffic is managed by the central hub that provides a facility to trade contact centre agent resource in a commercial context.

For example, a main contract may be put in place between independent contact centres and the central processing hub to govern, for example, prices/charging rates for both the routing of a communication contact from a contact centre and the routing of a contact to a contact centre thereby establishing a corresponding trade in contact centre agent resource. Charging may be calculated at the time of transaction or set in advance by the contract. According to a specific implementation, the time taken for a communication contact to be routed is monitored by the central processing hub and this time period may form the basis of the commercial transactions between the hub and the contact centres involved in the specific contact overflow trade. Alternatively, the number of communication contacts routed to and from any one contact centre may form the basis of the transaction between the central hub and any one of the contact centres. Accordingly, possible pricing scenarios include: dynamic/real time negotiation and market forced pricing; pre-negotiated pricing; fixed rate pricing; capped pricing; volume and/or minimum volume/pricing; unmetered pricing; or customer specific pricing requirements. According to specific pricing mechanisms, subsequent invoicing and settlement by the contact centres may be actioned and managed by the central processing hub.

According to a first aspect of the present invention there is provided load balancing apparatus configured for routing communication contacts between a plurality of contact centres comprising: means to receive a communication contact from a contact centre; means to select a contact centre from said plurality of contact centres to receive said communication contact based on a plurality of contact routing conditions; means to associate data with said communication contact; means to route said communication contact and said data to the selected contact centre; means for generating and presenting an interface platform to said selected contact centre, said interface platform configured to present data and allow data input at said contact centre; wherein said apparatus is capable of load balancing communication contacts between said plurality of contact centres operating under different communication contact management systems.

The apparatus may further comprise a database configured to store data presented and input at the contact centre. The apparatus may further comprise means to monitor a processing of the communication contact by the contact centre and means for attaching a connection identification to the communication contact, the communication identification being used by the means to monitor the processing of the communication contact. Means to queue the communication contact may be provided being operative whilst the means to select selects the appropriate contact centre from the plurality of contact centres.

The apparatus may further comprise guide means configured to enable the selected contact centre to process the communication contact, the guide means possibly being presented via the interface platform. Alternatively, the guide means may be audible data received by the agent at the contact centre.

The means to generate and present an interface platform may be configured to access an alternative interface, for example, an internet web page such that data may be input via the web page or alternatively the interface platform may be configured to correspond to the internet web page. Additional means may be provided to notify a contact centre from which the communication contact is routed of a processing problem encountered by the contact centre to which the call is routed starting a workflow process.

The means for generating and presenting the interface platform is configured to provide a universal platform allowing data presentation and data input across the plurality of contact centres being configured specifically to correspond to the process of any one of the contact centres. For example, the order, size and general presentation of the data input fields of the interface may be selectively configured.

The present invention is configured for load balancing across a plurality of contact centres that may or may not differ with regard to their call management systems.

Optionally, a contact communication may be received directly at the central hub and distributed according to any one or a combination of the plurality of contact routing conditions. The central hub is therefore configured to receive contact communications directly or via any one contact centre.

According to a second aspect of the present invention there is provided resource transaction apparatus configured to trade resource between a plurality of contact centres comprising: means to receive a communication contact from a contact centre; means to select a contact centre from said plurality of contact centres to receive said communication contact based on a plurality of contact routing conditions; means for monitoring a processing of said communication contact by said contact centre; means for generating and storing audit trail data for said plurality of contact centres based on the routing of communication contacts between said plurality of contact centres; means for processing said audit trail data at a central hub wherein resource traded between said plurality of contact centres may be transacted.

According to a third aspect of the present invention there is provided a method of transacting resource traded between a plurality of contact centres comprising: receiving a communication contact from a first contact centre; selecting a second contact centre from said plurality of contact centres; monitoring a processing of a communication contact routed from a first contact centre to a second contact centre; generating audit trail data for said first contact centre and said second contact centre based on routing of said communication contact from said first contact centre to said second contact centre; processing said audit trail data at a central hub, wherein resource traded between said first contact centre and said second contact centre may be transacted by said central hub.

According to a fourth aspect of the present invention there is provided a method of load balancing communication contacts between a plurality of contact centres comprising: receiving a communication contact from a contact centre; selecting a contact centre from said plurality of contact centres to receive said communication contact based on a plurality of contact routing conditions; associating data with said communication contact; routing said communication contact and said data to said contact centre; generating an interface platform configured to present data and allow data input at said contact centre; presenting said interface platform at said contact centre; and balancing communication contacts between said plurality of contact centres wherein said plurality of contact centres may be operating under different communication contact management systems.

According to a fifth aspect of the present invention there is provided a method of compiling at least one transaction between a centralised load balancing hub and any one contact centre of a plurality of contact centres based on resource traded between said plurality of contact centres comprising: receiving a communication contact from a contact centre; selecting a contact centre from said plurality of contact centres to receive said communication contact based on a plurality of contact routing conditions; assigning a connection identification to said communication contact; monitoring a processing of said communication contact at the selected contact centre using said connection identification; generating audit trail data for the contact centre from which the communication contact was received and the selected contact centre to which the communication contact was routed; processing said audit trail data using at least one economic transaction algorithm; wherein resource may be traded between said plurality of contact centres via said centralised load balancing hub.

According to a sixth aspect of the present invention there is provided centralised load balancing apparatus configured for routing communication contacts between a plurality of contact centres comprising: a contact routing manager configured to select a contact centre from said plurality of contact centres to process a communication contact received from a loaded contact centre; a data association manager configured to associate data with said communication contact; a routing engine configured to route said communication contact to the selected contact centre; a customer relationship manager configured to generate and present an interface platform to said selected contact centre, said interface platform configured to present data and allow data input at said selected contact centre; a database configured for storing data presented and input at said selected contact centre; wherein said apparatus is capable of load balancing communication contacts between said plurality of contact centres operating under different local communication contact management systems.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 herein illustrates schematically a central processing hub being networked with a plurality of non-associated contact centres;

FIG. 2 herein illustrates selected components of the central processing hub;

FIG. 3 herein illustrates selected components of the customer relationship manager;

FIG. 4 herein illustrates selected components of the contact routing manager;

FIG. 5 herein illustrates selected contact routing conditions;

FIG. 6 herein illustrates selected components of a contact centre;

FIGS. 7 and 8 herein illustrates a flow diagram of the load balancing between contact centres undertaken by the central processing hub;

FIG. 9 herein illustrates a database of the central processing hub and a contact centre database;

FIG. 10 herein illustrates the compiling of an economic transaction between the central processing hub and a plurality of contact centres;

FIG. 11 illustrates a further specific implementation of the present invention involving multiple central call distribution hubs.

### DETAILED DESCRIPTION

There will now be described by way of example a specific mode contemplated by the inventors. In the following description numerous specific details are set forth in order to provide a thorough understanding. It will be apparent however, to one skilled in the art, that the present invention may be practiced without limitation to these specific details. In other instances, well known methods and structures have not been described in detail so as not to unnecessarily obscure the description.

Within this specification the term ‘contact centre’ refers to an organisation housing a collection of individual agents or technology configured to process and respond to any communication contact. An alternative term used within the art is ‘call centre’.

Within this specification the term ‘communication contact’ refers to a synchronous and an asynchronous contact from a user/customer/prospect wishing to contact an organisation or company. The term ‘communication contact’ refers to the communication between a user and the contact centre or contact centre agent, via any one of a plurality of different media, being for example, but not limited to email, telephone, web or internet, short messaging service.

Within the specification the term ‘communication contact management system’ refers to the apparatus and process utilised by the contact centre in the handling of communication contacts. This term includes in particular, consideration of customer and contact management processes, a customer relationship management system, a communication contact routing management system, a data presentation and data input interface platform, a configuration of a database configured to store data relating to the communication contact.

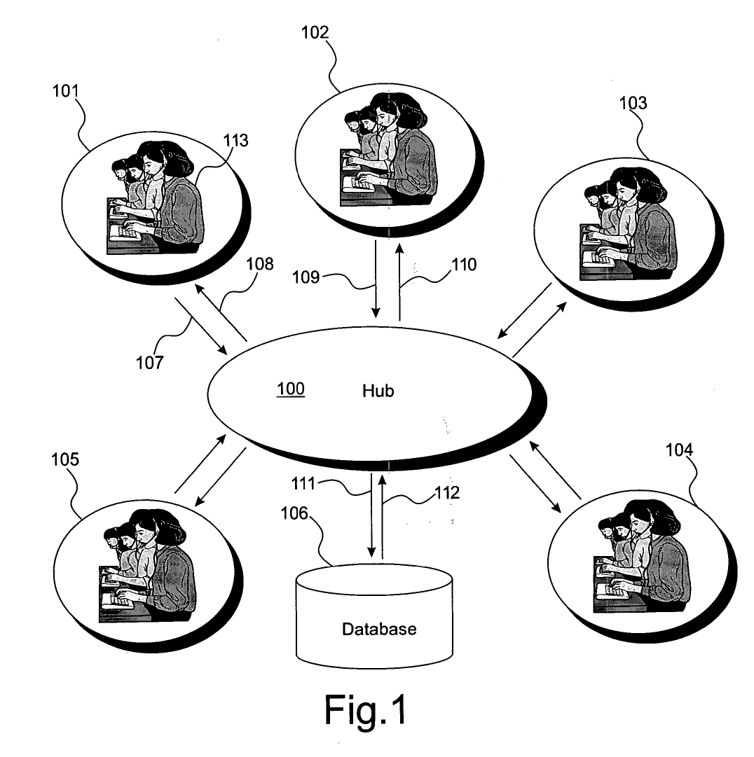

FIG. 1 herein illustrates schematically a central processing hub 100; a plurality of non-associated contact centres 101, 102, 103, 104, 105 and; a storage database 106. The plurality of contact centres 101 to 105 are connected to the central hub by way of a Virtual Private Network (VPN) capable of carrying voice and data. Communication hardware, software and media useable with the present invention include networks comprising Public Switched Telephone Networks (PSTN), Packet Switched Networks (e.g. voice over internet protocol (VoIP) wireless communication network, etc). Each of the contact centres and central processing hub comprise network hardware, port and drivers, commonly found in the art configured to allow data transfer between remote organisations. The centralised hub may or may not be connected directly to the PSTN or telephony network.

In operation, a communication contact received at contact centre 101 may enter a queue if agent resource is unavailable. If a call remains in the queue beyond a pre-determined waiting time, intelligence within the contact centre's automated call distribution switch (ACD) routes the communication contact 107 to a queue associated with or at the central hub 100, whilst an appropriate contact centre (102 to 105) is selected to process the communication contact based on various contact routing conditions. Once an appropriate contact centre has been identified relevant data and process from database 106 is attached to the communication contact 111 and 112, and the communication contact and data are routed to the selected contact centre 110. Following processing of the call by an agent at the contact centre, data input by the agent is passed back to the hub 109 to enable database 106 to be updated (111) and/or update of a database at contact centre 101 (108).

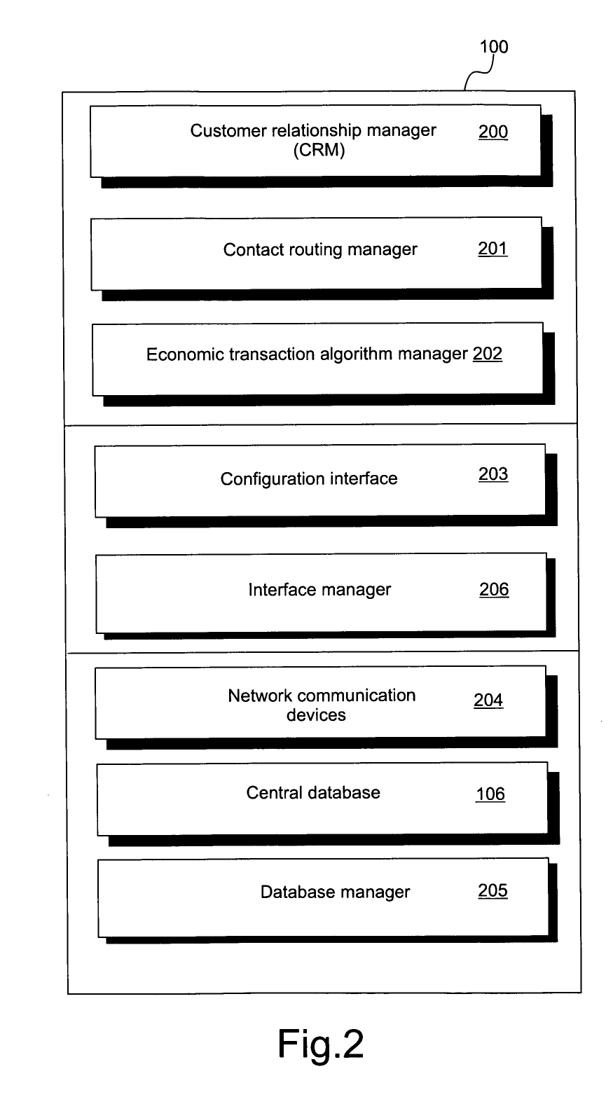

Referring to FIG. 2 herein there is illustrated selected components of the central processing hub 100 comprising a customer relationship manager (CRM) 200; a contact routing manager 201; a economic transaction algorithm manager 202; a configuration interface 203; an interface manager 206; network communication devices 204; a central database 106 and database manager 205.

The CRM 200 performs the interface function between the plurality of contact centres enabling data presentation and data input by agents 113 at the contact centres during contact processing. A contact routing manager 201 is configured to monitor the status of agents 113 across the plurality of contact centres and to identify an appropriate, available agent, in real-time and on-demand to process a communication contact overflowed to the central hub 100 from a loaded contact centre. The contact routing manager 201 is further configured to associate or attach data from at least one central database to be used in the processing of the communication contact.

The hub, acting as a centralised service provider, effectively enables resource capacity (or conversely communication contacts) to be traded between contact centres allowing communication contacts to be better managed and/or handled where fluctuations in contact traffic intensity may otherwise result in a communication contact queuing at any one particular contact centre longer than is desirable. According to the present invention apparatus and method are provided for the management of contact transfers as commercial transactions in that non-associated, individual contact centres trade resource capacity, on a buy and sell basis, via the central hub. At least one economic transaction algorithm 202 is utilised by the central hub to enable economic transactions to take place between the hub and any one of the contact centres based on resource capacity effectively bought and sold.

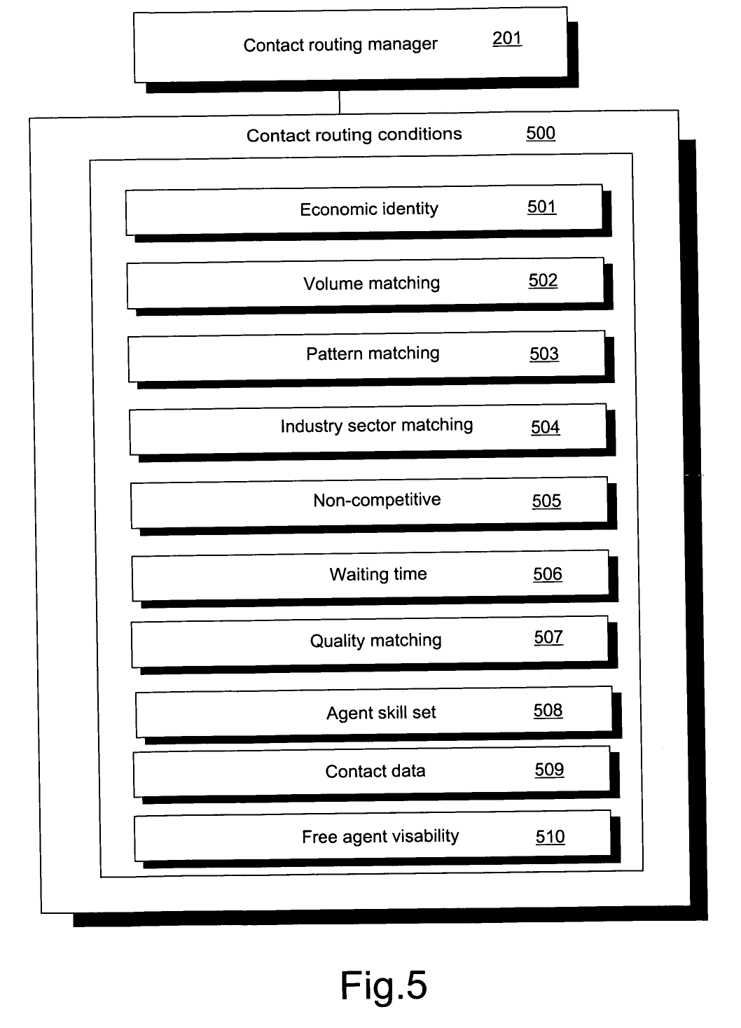

The configuration interface 203 is configured to allow a centralised technician to both configure the centralised hub initially and allow amendment or update of various operating parameters, in particular contact routing conditions as detailed with reference to FIG. 5 herein. Network communication devices 204 may comprise combinations of known network devices to enable network communication. The central database 106 is configured to store communication contact relevant data as a unified data collection or via a partitioned configuration, the central database collating relevant, selected data, stored by each contact centre. By way of example, and referring to FIG. 1 herein, when a call is routed from call centre 101 to call centre 102, an agent at call centre 102 is presented with the relevant data from database 106 which would otherwise have been available to an agent at contact centre 101 (via a database) to enable communication processing. The database manager 205 is configured to update central database 106 in response to both i) data input by an agent at any one contact centre and ii) database configuration changes managed remotely by each communication contact management system at each contact centre. The interface manager 206 is configured to ensure that the centralised hub and the contact centre's own data stores exchange data as is required and appropriate whilst providing the integrity and interfaces between the two systems.

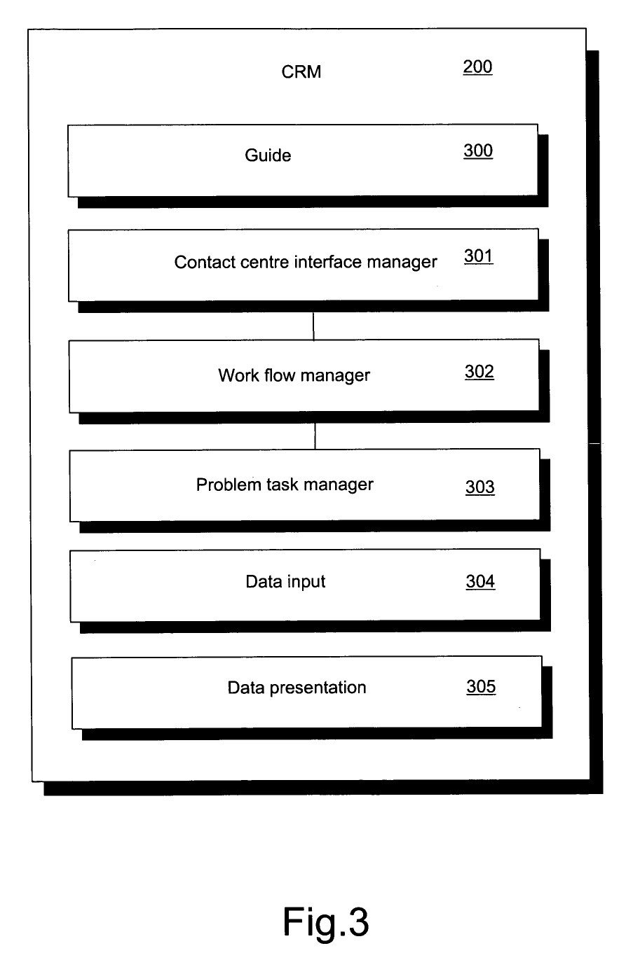

FIG. 3 illustrates a selected components of the customer relationship manager 200 comprising a guide 300; contact centre interface manager 301; workflow manager 302; problem task manager 303; data input 304 and data presentation 305.

Although not needed in all cases the guide 300 forms part of the universal interface platform presented at any one of the plurality of contact centres and is configured to enable an agent 113 to process a communication contact. The guide may comprise audio or visual display scripts configured to prompt or guide the agent through the communication contact processing operation. The guide may be configured initially with the initial hub configuration and may be updated in response to communication contact processing changes at any one of the contact centres. The contact centre interface manager 301 is configured to generate and present a compatible interface at any one of the plurality of contact centres operating under different communication contact management systems. Data may be presented and input at a contact centre user interface via interface fields. For example, an agent at contact centre 102 is presented with a user interface comprising an arrangement of fields that is familiar and therefore user-friendly to the agent who may be unfamiliar with processing a communication contact which has been routed from and which is normally processed by a different contact centre.

According to the specific implementation of the present invention the customer relationship manager, to enable communication contact processing, is configured to call-up an appropriate, alternative interface (e.g. a web page allowing data input) as a substitute to the generating and presenting of a user interface issued from the central hub. The problem task manager enables an agent, experiencing difficulties or problems with the processing of a communication contact, to query specific points and/or to notify the central hub and other contact centres of for example, incomplete processing of a communication contact. For example, a workflow may be started by an email being sent via the central hub from the contact centre attempting to process the contact to the source contact centre in an attempt to address any problems quickly or to simply flag-up incomplete processing.

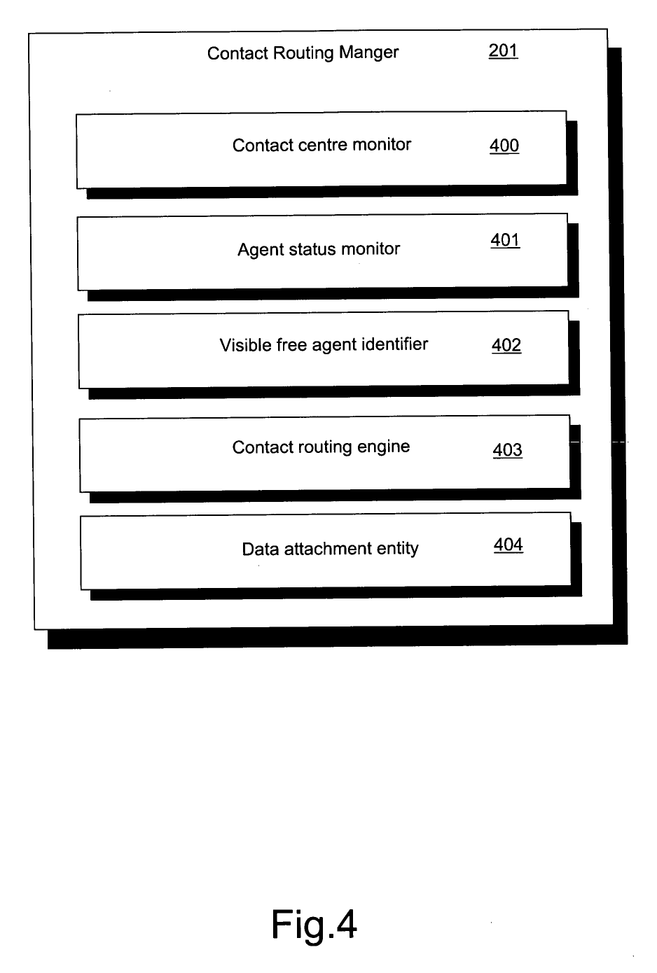

FIG. 4 herein illustrates selected components of the contact routing manager 201 comprising contact centre monitor 400; agent status monitor 401; visible free agent identify 402; contact routing engine 403; and data attachment entity 404. In operation, central hub 100 is configured to monitor contact traffic through each of the networked contact centres in real-time or near real-time using contact centre monitor 400. The agent status monitor 401 is configured to monitor agent resource capacity of individual agents at each contact centre and to identify visible free agents using identifier 402. An agent is visible according to pre-determined business rules or contact routing conditions such as the agent skill set. For example, a German speaking agent would not be visible when selecting agent resource capacity configured to process a communication contact requiring the agent to speak French. Once an agent has been identified to process a call, data attachment entity 404 selects and attaches the relevant data from database 106 which may then be routed to the receiving agent together with the call using routing engine 403. The routing engine is configured to transfer communication contact and data via interfaces whereby the plurality of contact centres transfer data to and from the central hub and not directly with each other.

FIG. 5 herein illustrates selected contact routing conditions 500 used by contact routing manager 201 to action transfer of contact traffic between contact centres. The contact routing conditions define operating conditions under which the central hub overflows communication contacts from a first contact centre to a second contact centre. A plurality of routing conditions may be set initially and subsequently amended via the configuration interface 203.

The economic identity 501 may be based on a profitability rating of a particular contact centre, being in turn, determined by the contract between the hub and the contact centre. That is, all things being equal between contact centres, a communication contact may be routed to the contact centre which allows the greatest commercial gain. Contact centres may be matched on a volume matching condition 502 whereby calls are overflowed from a first contact centre to a second contact centre of similar size and capacity (e.g. number of skilled agents). Communication contacts may be overflowed by consideration of contact centre pattern matching 503 based on, for example, time of day dependent traffic intensity. Communication contact may preferably be routed to contact centres operating within the same industry sector (industry sector matching 504); the processing of a contact by a different contact centre within the same industry potentially being more efficient (due to agent-subject matter familiarity) than a contact processed by a contact centre operating in a different market sector. Consideration may also be given to, i) the level of competition between industries and contact centres 505, ii) the quality of communication contact handling by the agents 507, iii) the agent skill set 508 and iv) the data related to the communication contact itself 509. In particular, appropriate resource may be selected based on the telephone line by which the contact communication is inbound. A contact communication identification, assigned to the communication contact may also serve as basis for selecting appropriate resource. Further, when selecting and routing communication contacts to visible free agents, the queue waiting time threshold, set by the hub or contact centre, may be considered.

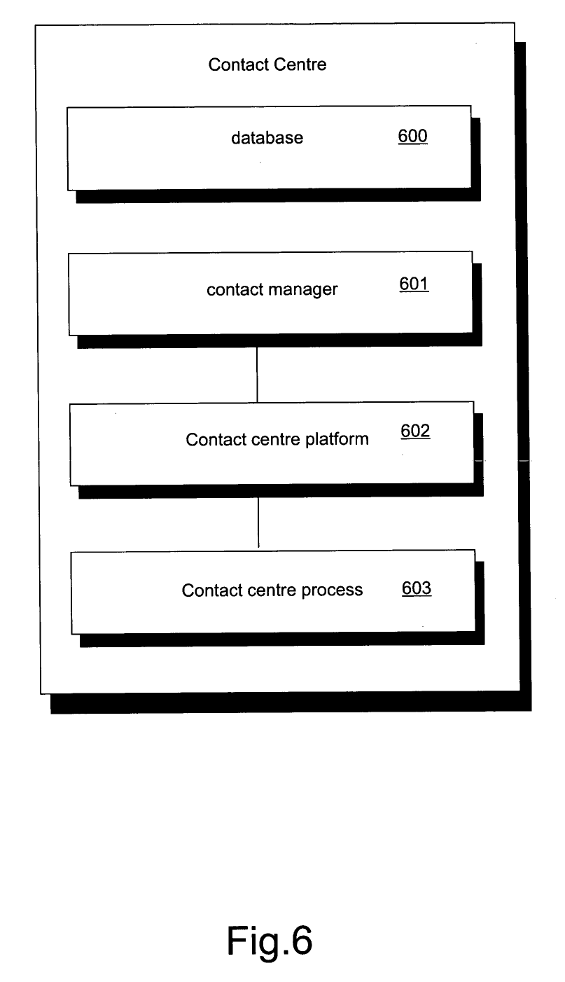

FIG. 6 herein illustrates selected components of a contact centre comprising a database 600; a contact manager 601; a contact centre platform 602 and a contact centre process 603. The CRM of the present invention is configured to provide a universal interface platform and data storage and retrieval system, compatible with the contact traffic management system and associated various components of the remote contact centres 600, 601, 602, 603.

Prior art contact traffic management systems function to overflow or load balance communication traffic between contact centres operating under identical or near-identical contact management systems and processes with regard to their database configuration, call waiting system or contact manager 601, data input and display platform 602 and contact centre specific processes 603. The present invention goes beyond existing contact traffic load balancing systems by providing apparatus and method configured to integrate contact centres operating under different management systems involving differences between configurations 600 to 603.

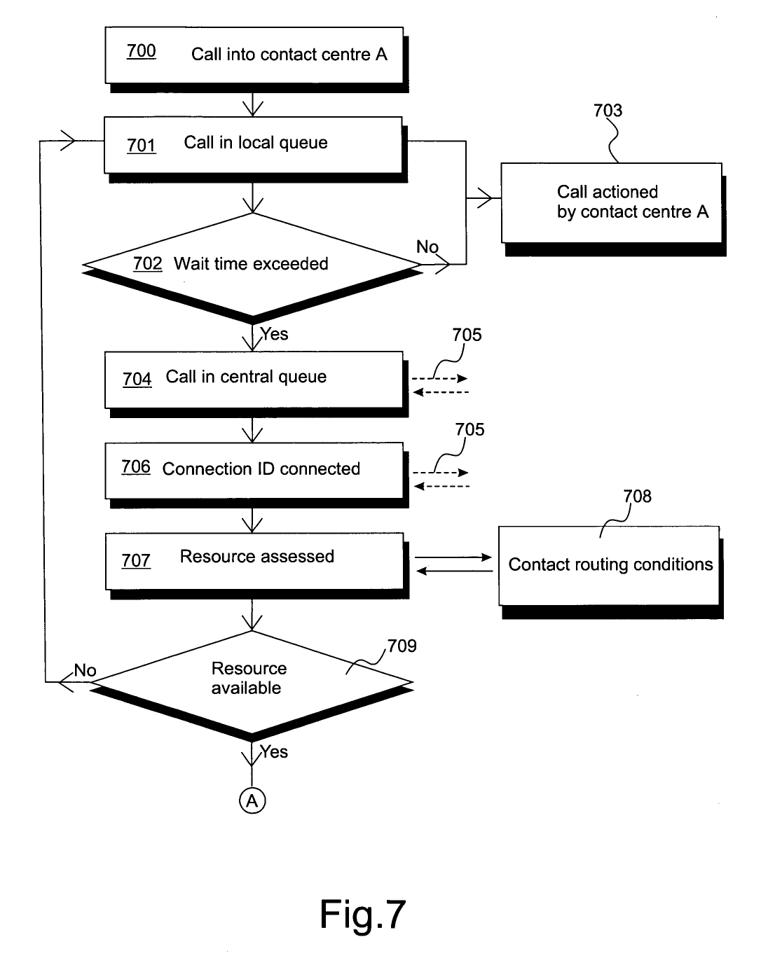

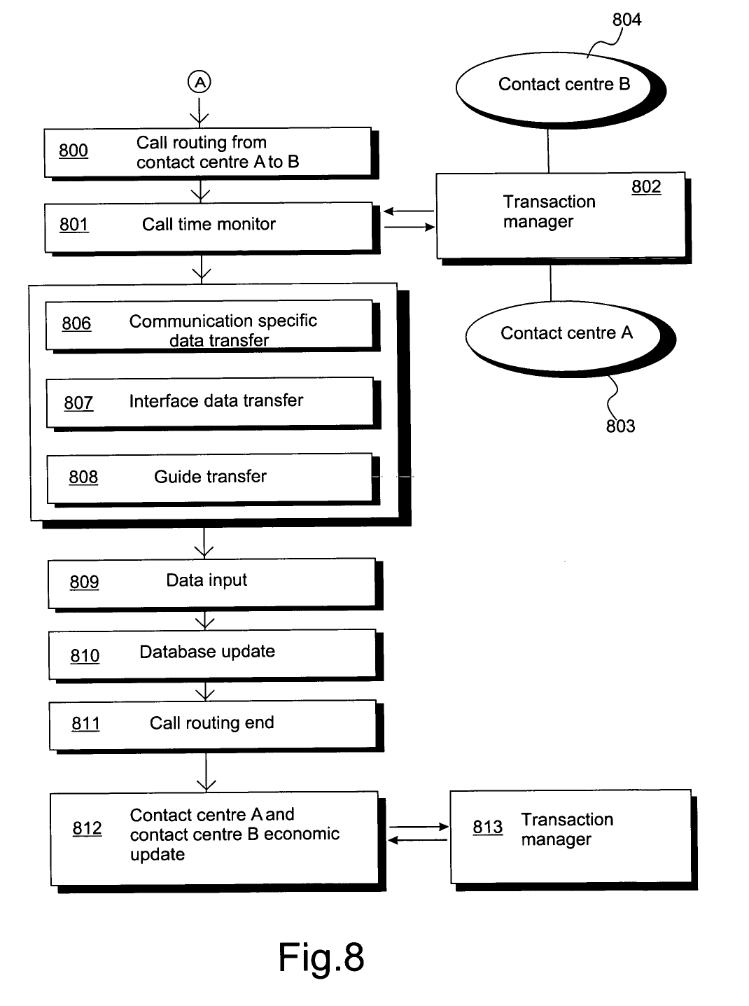

FIGS. 7 and 8 herein illustrate a flow diagram of the load balancing between the contact centres by the central processing hub. A user wishing to contact an organisation, initiates a contact by whichever medium is most convenient or available e.g. email, telephone, web/internet, short messaging service. The contact initiated by the user reaches the contact centre to which it is originally directed 700.

As in the prior art, the contact is normally filtered by the contact centre according to its own business rules or contact routing conditions for dealing with such contacts, resulting in a resource availability search to enable the contact to be processed. If resource is available contact processing is fulfilled 703. If not, the contact remains in a queue 701 until such time as resource becomes available. Contacts are recycled until resource becomes available or until, for example, the contact wait time exceeds a threshold determined in advance by the contact centre.

If the contact wait time exceeds the threshold, a request or purchase order is placed by the contact centre with the hub for external resource to fulfill and process the waiting communication contact. The contact then enters a central queue 704 and the process of centralised monitoring of the contact is initiated 705. A connection identification is associated with the contact 706 by the routing contact manager as part of the contact monitoring process.

At step 709, the hub searches for available resource at other contact centres appropriate to handle the overflow contact. The hub achieves this via the contact routing manager and in particular the selected components 400 to 402 and the associated contact routing conditions 500 detailed with reference figures to FIGS. 4 and 5 herein. Database 106 is also accessed at this time for information concerning the status of the resource of each of the other contact centres. Status data may also be provided regularly by resource controllers of the contact centres or in real time via interfaces.

If no resource is available at the time of the search 709, the communication contact from the contact centre which has overflowed the contact (the purchaser) to the central hub, remains in the queue and is recycled again. If resource is identified during the search, according to the contact routing conditions, the resource is locked via the contact routing manager. A buy and sell transaction is then established with the central hub and the contact centre responsible for the resource (the vendor) and the purchaser contact centre. Matters pertaining to the contract e.g. the identification of the contracting parties, the basis upon which the resource capacity is supplied by the vendor and charged to the purchaser, the relevant statistics and activity reports and billing processes are dealt with by the hub.

Referring to FIG. 8 herein, once resource has been identified, the contact is transferred from the central hub to the selected contact centre, step 800. According to the specific implementation of the present invention, once the communication contact has been successfully routed to the receiving contact centre the call time is monitored by the contact routing manager 801. The trade in resource capacity between contact centre A (803) and contact centre B (804) is managed by the transaction manager 802 based upon the time taken to process the routed contact.

To enable the agent to process the contact at contact centre B, the hub transfers data specific to the communication contact, for example a caller's personal and account details. Data relating to the interface to be used by contact centre B during processing of the communication contact is also transferred. In addition, the hub initialises and transfers any necessary scripts forming the on-screen or audible guide 808. The contact is then processed by the agent involving data input 809.

When contact processing is complete the call routing is terminated 811 and the economic status between contact centre A, contact centre B and the central hub is updated 812 via the transaction manager 813.

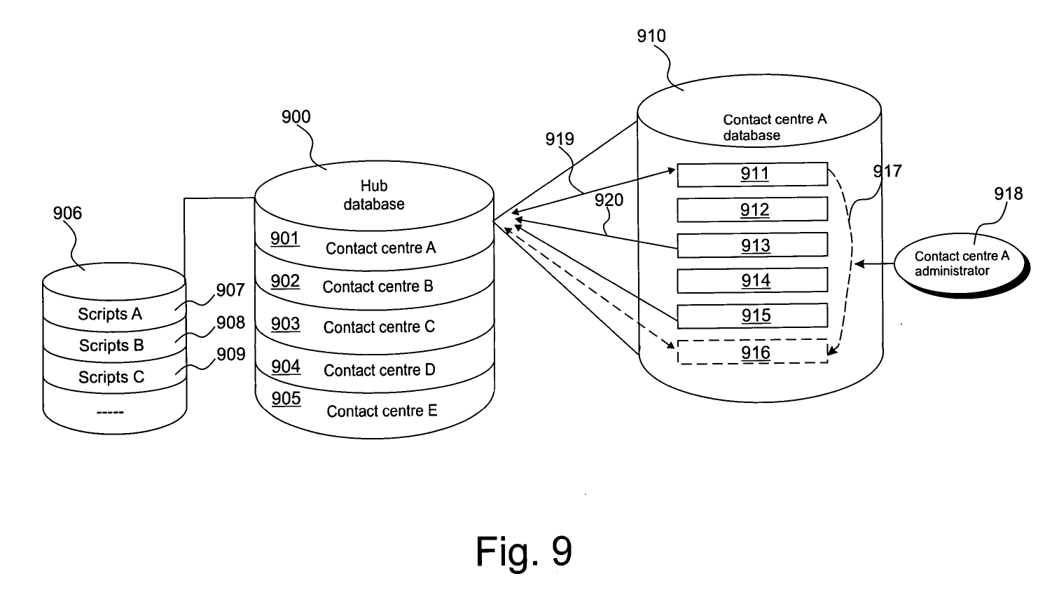

FIG. 9 herein illustrates schematically the centralised hub database 900 and a contact centre database 910. The centralised hub database may be partitioned according to each of the remote contact centres connected to the central hub via the VPN. Secondary or further databases 906 may be interconnected with the central database 900, configured to collate and store additional information, for example the scripts being used by guide 300 and interface configuration used by interface manager 301 to enable agents to process contacts at contact centres A to C (907 to 909, respectively).

Data accessed during fulfillment of contact processing may be in real-time or drawn from a batch file utilising database 106. The data captured during processing of the contact can be returned via the central processing hub to the original contact centre or through real-time interfaces. Both batch and a real-time interfaces can be set up to deliver the information to and from the central processing hub according to specific implementations of the present invention.

For example, the central hub may be configured to store and access selected data fields 911 to 916 of the remote database 910. Data transfer may be bidirectional 919 or monodirectional 920 depending upon preconditions set by the contact centre and/or central hub. Moreover, database 900 is configured to be updated in response to data partitioning or storage change 917 by a contact centre administrator 918. Data access and retrieval is therefore not compromised by data storage changes.

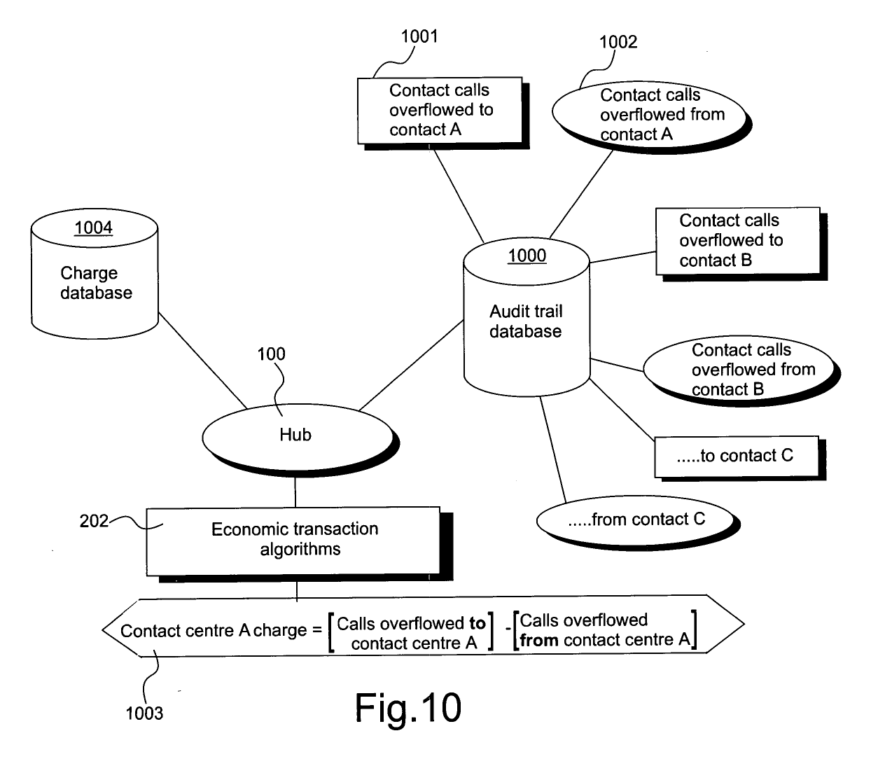

Referring to FIG. 10 herein, the present invention provides a centralised system offering contact resource centre capacity to be traded as a marketable commodity. Contact centre resource capacity may be transacted in real-time and on-demand in response to fluctuations in contact traffic intensity. In operation, a main contract is put in place to govern among other matters, data transmissions, and prices, charging rates for overflowing and processing contacts. Prices may be calculated at the time of transaction, in advance of or post contact. A plurality of pricing scenarios may be accommodated within the present invention, for example, but not limited to:
Dynamic/real-time negotiation and market forced pricing
Pre-negotiated pricing;
Fixed rate pricing;
Capped pricing;
Volume pricing;
Minimum volume pricing

In order to compile an economic transaction between the hub and any one of the plurality of contact centres, the hub 100 collates data from an audit trail database 1000 based on the volume of contact calls overflowed to a contact centre 1001 and contact calls overflowed from the same contact centre 1002. The audit trail database may be partitioned according to each contact centre to enable a net economic standing to be calculated based on resource bought and sold by a particular contact centre. A separate charge database 1004 is configured to store data specific to the contract between the hub and each contact centre. For example, a profitability or commercial identifier rating may be included in the compiling of the economic statement between the hub and the contact centre. The audit trail data and any other economic weighting factors are processed involving at least one economic transaction algorithm 202 to generate economic statement 1003 based on calls overflowed to and from the contact centre.

According to specific implementations of the present invention the central processing hub is configured for subsequent billing and settlement of accounts with the plurality of contact centres using pricing mechanisms and infrastructure found in the art.

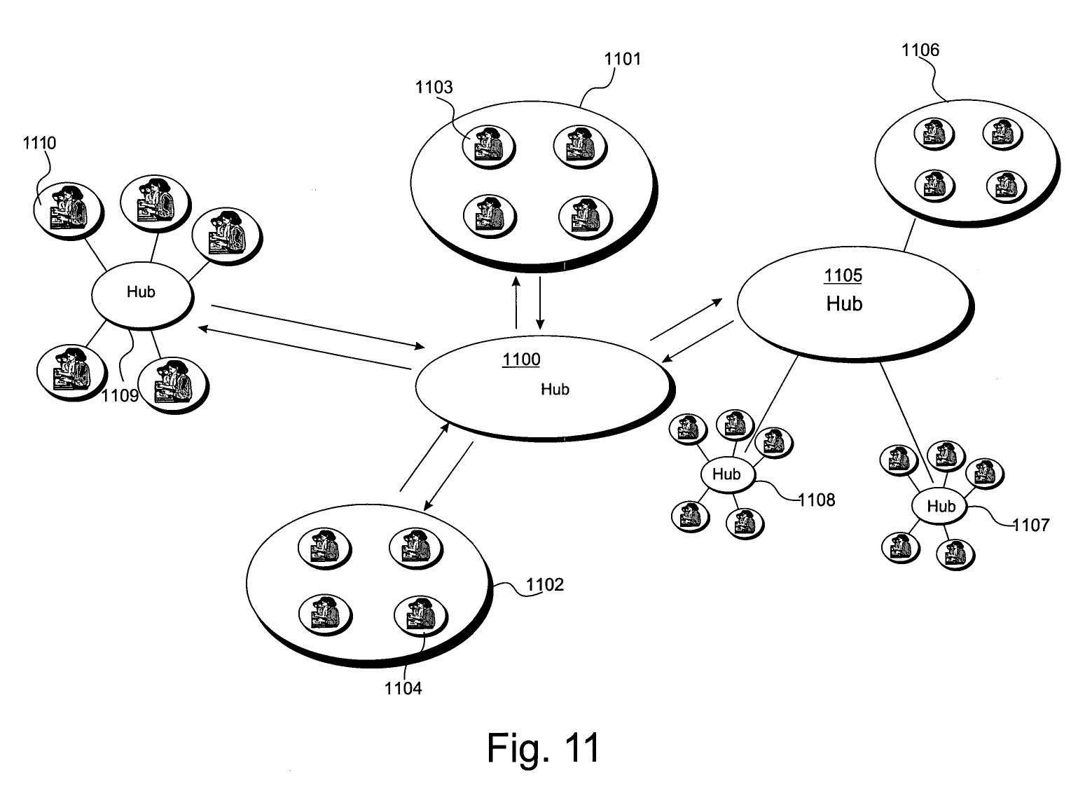

FIG. 11 herein illustrates schematically further specific implementations of the present invention involving multiple centralised call distribution hubs extending over a network of individual and grouped contact centres. Central hub 1100 may be networked with a plurality of contact centres 1103, 1104 configured in groups 1101, 1102 based on criteria including call handling quality, economic identity, traffic volume, traffic type, industry sector, non-competitiveness and/or communication contact waiting time. Central hub 1100 may be networked with further hubs 1105 which in turn may be networked with a plurality of grouped contact centres 1106, or hubs 1107, 1108. Further centralised processing hubs may be included in the VPN 1109 being networked directly with the non-associated contact centres 1110 as detailed with reference to FIG. 1 herein.

1. Load balancing apparatus configured for routing communication contacts between a plurality of contact centres comprising:
means to receive a communication contact from a contact centre;
means to select a contact centre from said plurality of contact centres to receive said communication contact based on a plurality of contact routing conditions;
means to associate data with said communication contact;
means to route said communication contact and said data to the selected contact centre;
means for generating and presenting an interface platform to said selected contact centre, said interface platform configured to present data and allow data input at said contact centre;
wherein said apparatus is capable of load balancing communication contacts between said plurality of contact centres operating under different communication contact management systems.

2. The apparatus as claimed in claim 1 further comprising a database configured to store the data presented and input at said contact centre.

3. The apparatus as claimed in claim 1 further comprising means to monitor a processing of said communication contact by said contact centre after said contact centre is selected by said means to select.

4. The apparatus as claimed in claim 1 further comprising means for attaching a connection identification to said communication contact, said communication identification being used by said means to monitor said processing of said communication contact.

5. The apparatus as claimed in claim 1 further comprising means to queue said communication contact whilst said means to select selects said contact centre from said plurality of contact centres to receive said communication contact.

6. The apparatus as claimed in claim 1 further comprising guide means configured to enable the selected contact centre to process said communication contact.

7. The apparatus as claimed in claim 1 wherein said means to generate and present an interface platform is configured to access an existing alternative interface wherein said interface platform is based on said alternative interface.

8. The apparatus as claimed in claim 1 further comprising means to notify a contact centre from which said communication contact is routed of a processing problem encountered by a contact centre to which said communication contact is routed.

9. The apparatus as claimed in claim 1 further comprising a centralised interface platform configured to allow a user to amend said plurality of contact routing conditions.

10. The apparatus as claimed in claim 1 wherein said plurality of contact routing conditions comprise a selection of any one or a combination of the following set of:
a contact centre profitability rating;
contact centre volume matching;
contact centre pattern matching;
industry sector matching;
non competitive contact centres;
communication contact waiting time;
quality matching;
contact data;
contact centre agent skill set;
free agent visibility.

11. The apparatus as claimed in claim 1 wherein said means for generating and presenting said interface platform is configured to provide a universal platform allowing data presentation and data input across said plurality of contact centres, said universal platform configured specifically to correspond to an interface platform of any one contact centre of said plurality of contact centres.

12. The apparatus as claimed in claim 1 wherein said communication management systems of said plurality of contact centres may differ in any one or a combination of the following set of:
customer and contact management processes;
a customer relationship management system;
a communication contact routing management system;
a data presentation and input interface platform;
a configuration of a database configured to store data relating to said communication contact.

13. Resource transaction apparatus configured to trade resource between a plurality of contact centres comprising:
means to receive a communication contact from a contact centre;
means to select a contact centre from said plurality of contact centres to receive said communication contact based on a plurality of contact routing conditions;
means for monitoring a processing of said communication contact by said contact centre;
means for generating and storing audit trail data for said plurality of contact centres based on the routing of communication contacts between said plurality of contact centres;
means for processing said audit trail data at a central hub wherein resource traded between said plurality of contact centres may be transacted.

14. The apparatus as claimed in claim 13 further comprising at least one audit trail database configured for storing data generated from said routing of said communication contacts between said plurality of contact centres.

15. The apparatus as claimed in claim 13 further comprising at least one charge database configured for storing contact centre specific data being used by said means for processing.

16. The apparatus as claimed in claim 13 further comprising at least one economic transaction algorithm being configured to generate an economic transaction between said central hub and any one of said plurality of contact centres based on a routing and processing of said communication contacts between said plurality of contact centres.

17. The apparatus as claimed in claim 13 wherein said means to monitor said processing of said communication contact is configured to monitor a time taken to process said communication contact by the selected contact centre.

18. The apparatus as claimed in claim 13 further comprising means to attach a connection identification to said communication contact, said connection identification being used in the determination of the time taken to process said communication contact by the selected contact centre.

19. The apparatus as claimed in claim 13 further comprising means to generate an economic statement between any one contact centre of said plurality of contact centres and the central hub, said economic statement being based on the management and administration of resource traded between said plurality of contact centres by said central hub.

20. The apparatus as claimed in claim 13 wherein said central hub is configured to square out contact centre resource capacity by automatically matching short positions with long positions according to said plurality of contact routing conditions.

21. The apparatus as claimed in claim 13 wherein said central hub is configured to trade resource based on the time taken to process communication contacts routed from a first contact centre to a second contact centre and to compile a database for any one contact centre of data relating to communication contacts routed from and to any one contact centre.

22. The apparatus as claimed in claim 13 wherein said central hub is configured to trade resource based on a number of communication contacts routed from a first contact centre to a second contact centre and to compile a database for any one contact centre of data relating to communication contacts routed from and to any one contact centre.

23. The apparatus as claimed in claim 13 wherein said central hub is configured to transact a trade in resource between a plurality of contact centres according to any one or a combination of the following set of transaction models:
dynamic/real time negotiation and/or market forced pricing;
pre-negotiated pricing;
fixed rate pricing;
capped pricing;
volume pricing;
minimum volume and/or volume pricing;
unmetered pricing;
customer specific pricing requirements.

24. A method of transacting resource traded between a plurality of contact centres comprising:
receiving a communication contact from a first contact centre;
selecting a second contact centre from said plurality of contact centres;
monitoring a processing of a communication contact routed from a first contact centre to a second contact centre;
generating audit trail data for said first contact centre and said second contact centre based on the routing of said communication contact from said first contact centre to said second contact centre;
processing said audit trail data at a central hub, wherein resource traded between said first contact centre and said second contact centre may be transacted by said central hub.

25. The method as claimed in claim 24 further comprising attaching a connection identification to said communication contact prior to said step of routing said communication contact between contact centres.

26. The method as claimed in claim 24 further comprising the step of queuing said communication contact during said step of selecting a contact centre from said plurality of contact centres.

27. The method as claimed in claim 24 wherein said step of monitoring a processing of said communication contact involves monitoring the time taken by a selected contact centre to process a routed communication contact.

28. The method as claimed in claim 24 further comprising applying an economic transaction algorithm to said audit trail data to generate a transaction between said central hub and any one of said plurality of contact centres.

29. A method of load balancing communication contacts between a plurality of contact centres comprising:
receiving a communication contact from a contact centre;
selecting a contact centre from said plurality of contact centres to receive said communication contact based on a plurality of contact routing conditions;
associating data with said communication contact;
routing said communication contact and said data to said contact centre;
generating an interface platform configured to present data and allow data input at said contact centre;
presenting said interface platform at said contact centre; and
balancing communication contacts between said plurality of contact centres wherein said plurality of contact centres may be operating under different communication contact management systems.

30. The method as claimed in claim 29 further comprising monitoring a processing of said communication contact by the selected contact centre.

31. The method as claimed in claim 29 further comprising attaching a connection identification to said communication contact prior to said step of routing said communication contact to the selected contact centre.

32. The method as claimed in claim 29 further comprising queuing said communication contact prior to said step of routing said communication contact to the selected contact centre.

33. The method as claimed in claim 29 further comprising attaching guide data to said communication contact, said guide data being configured to enable an agent at the selected contact centre to process said communication contact.

34. The method as claimed in claim 33 wherein said guide data comprises at least one script being used by said agent to enable said agent to input data at said contact centre via said interface platform.

35. The method as claimed in claim 29 further comprising accessing an alternative interface and presenting said alternative interface at said contact centre, said alternative interface being configured to allow said data input at said centre in order to process said communication contact.

36. A method of compiling at least one transaction between a centralised load balancing hub and any one contact centre of a plurality of contact centres based on resource traded between said plurality of contact centres comprising:
receiving a communication contact from a contact centre;
selecting a contact centre from said plurality of contact centres to receive said communication contact based on a plurality of contact routing conditions;
assigning a connection identification to said communication contact;
monitoring a processing of said communication contact at the selected contact centre using said connection identification;
generating audit trail data for the contact centre from which the communication contact was received and the selected contact centre to which the communication contact was routed;
processing said audit trail data using at least one economic transaction algorithm;
wherein resource may be traded between said plurality of contact centres via said centralised load balancing hub.

37. Centralised load balancing apparatus configured for routing communication contacts between a plurality of contact centres comprising:
a contact routing manager configured to select a contact centre from said plurality of contact centres to process a communication contact received from a loaded contact centre;
a data association manager configured to associate data with said communication contact;
a routing engine configured to route said communication contact to the selected contact centre;
a customer relationship manager configured to generate and present an interface platform to said selected contact centre, said interface platform configured to present data and allow data input at said selected contact centre;
a database configured for storing data presented and input at said selected contact centre;
wherein said apparatus is capable of load balancing communication contacts between said plurality of contact centres operating under different communication contact management systems.

38. A method of load balancing communication contacts between a plurality of contact centres comprising:
receiving a communication contact at a central hub;
selecting a contact centre from said plurality of contact centres to receive said communication contact based on a plurality of contact routing conditions;
associating data with said communication contact;
routing said communication contact and said data to said contact centre;
generating an interface platform configured to present data and allow data input at said contact centre;
presenting said interface platform at said contact centre; and
balancing communication contacts between said plurality of contact centres wherein said plurality of contact centres may be operating under different communication contact management systems.
